(19) United States
(12) Patent Application Publication
(10) Pub. No.: US 2026/0063921 A1
(43) Pub. Date: Mar. 5, 2026

(54) OPTICAL MEMBER DRIVING MECHANISM

(71) Applicant: TDK TAIWAN CORP., Taoyuna City (TW)

(72) Inventors: Chia-Che WU, Taoyuan City (TW); Yi-Ho CHEN, Taoyuan City (TW); Yung-Yun CHEN, Taoyuan City (TW); Jui-Che MENG, Taoyuan City (TW)

(21) Appl. No.: 19/312,827

(22) Filed: Aug. 28, 2025

Related U.S. Application Data
(60) Provisional application No. 63/688,408, filed on Aug. 29, 2024.

(51) Int. Cl. G02B 27/64; G03B 5/00

(52) U.S. Cl. CPC G02B 27/646; G03B 5/00; G03B 2205/0007

(57) ABSTRACT

An optical member driving mechanism is provided. The optical member driving mechanism includes a movable portion, a fixed portion, and a driving assembly. The movable portion is configured to connect an optical member, and is movable relative to the fixed portion. The driving assembly is configured to drive the movable portion to move.

### CROSS REFERENCE TO RELATED APPLICATIONS

This application claims the benefit of U.S. Provisional Application No. 63/688,408, filed Aug. 29, 2024, the entirety of which is incorporated by reference herein.

### TECHNICAL FIELD

The present disclosure relates to an optical member driving mechanism, and, in particular, it relates to an optical member driving mechanism for driving an optical member to move.

### BACKGROUND

As technology has advanced, a lot of electronic devices (for example, tablet computers and smartphones) have been given the functionality of taking photographs and recording video. These electronic devices have become more commonplace, and have been developed to be more convenient and thin. More and more choices are provided for users to choose from.

When the user of an electronic device equipped with a lens module shakes the device, images captured by the camera via the lens module may turn out blurry. Since the requirements for image quality have increased, it has become more and more important to develop a lens module with zooming and vibration-proofing function.

### BRIEF SUMMARY

An embodiment of the present disclosure provides an optical member driving mechanism, including a movable portion, a fixed portion, and a driving assembly. The movable portion is configured to connect an optical member, and is movable relative to the fixed portion. The driving assembly is configured to drive the movable portion to move.

In some embodiments, the optical member driving mechanism can further include a guiding assembly, and the movable portion is movable relative to the fixed portion through the guiding assembly. The guiding assembly includes a guiding member and a first corresponding unit. The guiding member includes a main body having a longitudinal structure and a first fixing unit, and the first corresponding unit corresponds to the first fixing unit. The first fixing unit has a depression structure, and the first corresponding unit has a protruding structure entering the first fixing unit.

### BRIEF DESCRIPTION OF DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 is a schematic diagram of an optical member driving mechanism disposed in an electronic device according to an embodiment of the present disclosure;

FIG. 2 is a schematic diagram of the optical member driving mechanism according to an embodiment of the present disclosure;

FIG. 3 is an exploded-view diagram of the optical member driving mechanism according to an embodiment of the present disclosure;

FIG. 4 is a cross-sectional view taken along the line A-A in FIG. 2;

FIG. 5 is a cross-sectional view taken along the line B-B in FIG. 2;

FIG. 6A is a schematic diagram of a frame, a first circuit member, and a second circuit member according to an embodiment of the present disclosure;

FIG. 6B is a schematic diagram of the frame, the first circuit member, the second circuit member, and a first driving member according to an embodiment of the present disclosure;

FIG. 6C is a top view of the frame, the first circuit member, the second circuit member, and the first driving member according to an embodiment of the present disclosure;

FIG. 6D is a side view of the frame, the first circuit member, the second circuit member, and the first driving member according to an embodiment of the present disclosure; and

FIG. 7 is a cross-sectional view taken along the line C-C in FIG. 2.

### DETAILED DESCRIPTION

The making and using of the embodiments of the optical member driving mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

The following disclosure provides many different embodiments, or examples, for implementing different features of the subject matter provided. Specific examples of solutions and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

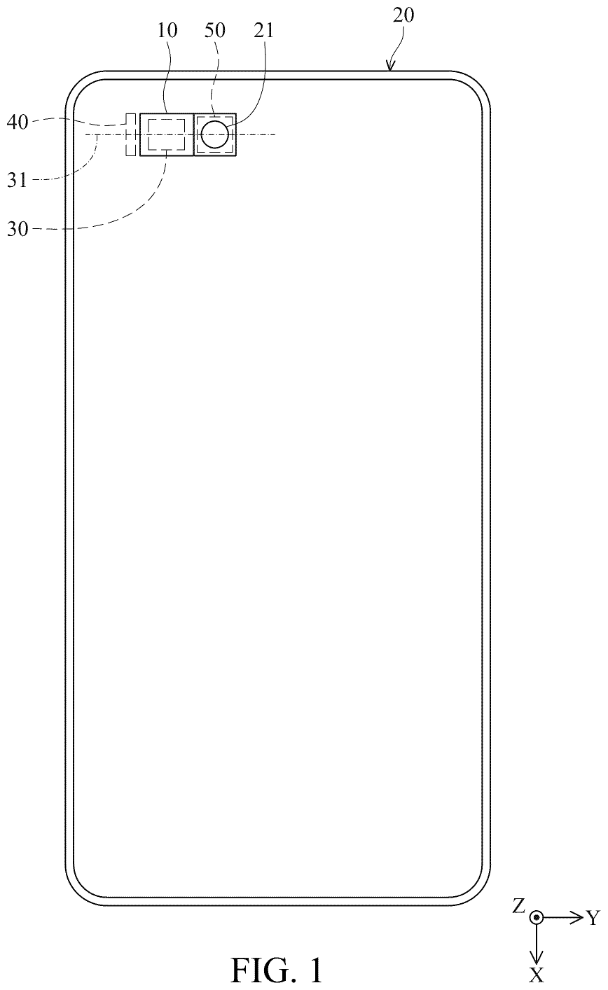

Referring to FIG. 1, an optical member driving mechanism 10 according to an embodiment of the present disclosure can be disposed in an electronic device 20, and can hold an optical member 30. When taking photographs or recording video, the external light can enter the electronic device 20 through a hole 21 thereof. The external light entering the electronic device 20 can be reflected by a reflecting member 50 and then move along the optical axis 31 of the optical member 30, and finally reach an image sensor 40 in the electronic device 20 to form an image on it. The optical member driving mechanism 10 can drive the optical member 30 to move relative to the image sensor 40, so as to achieve the purpose of focusing, zooming, and/or optical image stabilization (OIS). For example, the electronic device 20 can be a smartphone or a digital camera that is able to take photo or record video, the reflecting member 50 can be a prism or a reflecting mirror, and the optical member 30 can be a camera lens, but it is not limited thereto.

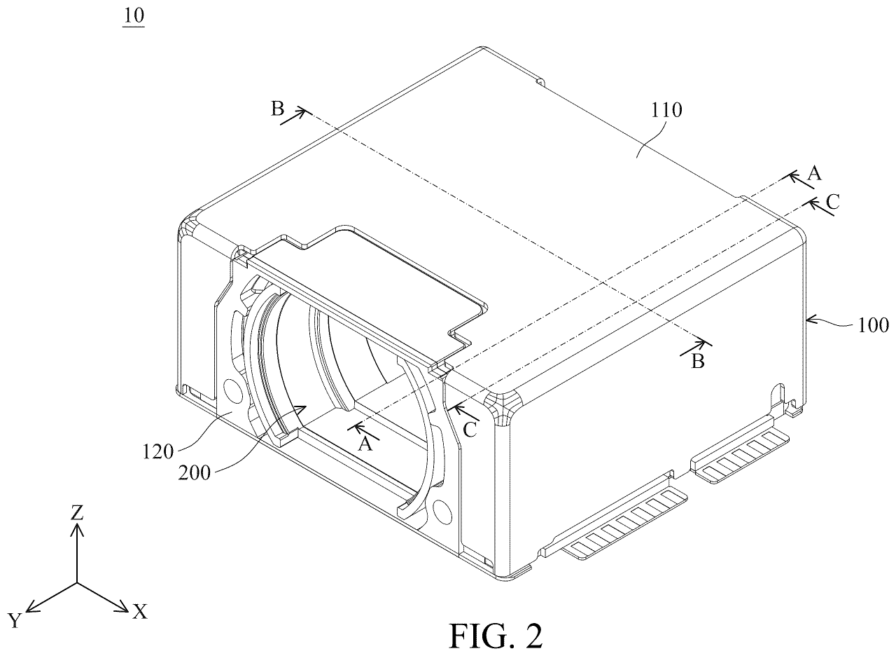

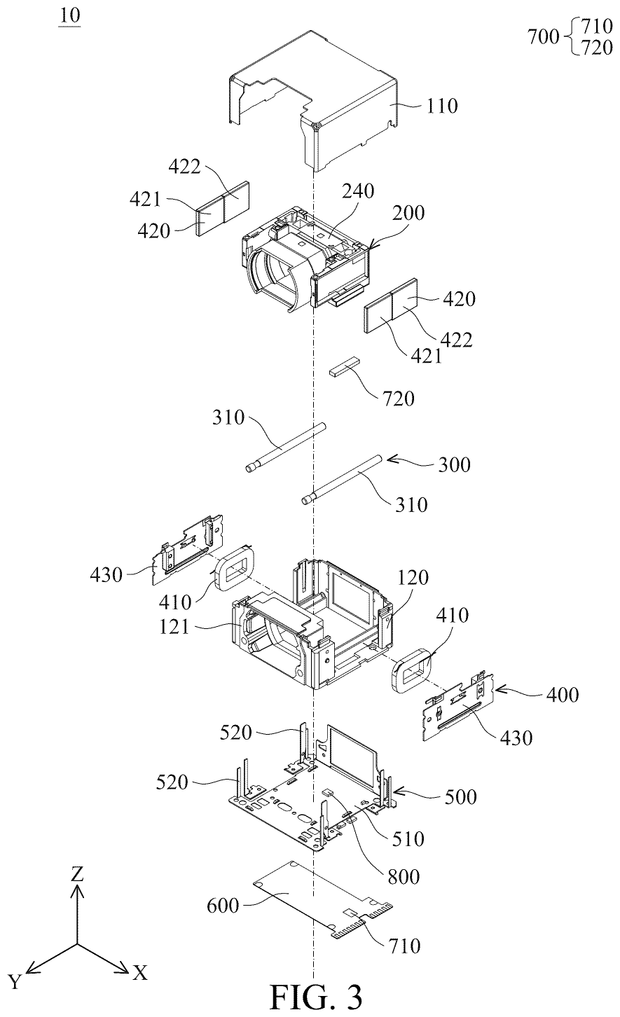

FIG. 2 is a schematic diagram of the optical member driving mechanism 10, and FIG. 3 is an exploded-view diagram of the optical member driving mechanism 10. As shown in FIG. 2 and FIG. 3, the optical member driving mechanism 10 primarily includes a fixed portion 100, a movable portion 200, a guiding assembly 300, a driving assembly 400, a reinforcing member 500, a circuit assembly 600, and a sensing assembly 700. The optical member 30 can be mounted on the movable portion 200, and the movable portion 200 can be movably connected to the fixed portion through the guiding assembly 300. The driving assembly 400 can provide a driving force to the movable portion 200 to move the movable portion 200 relative to the fixed portion 100. The driving assembly 400 can be electrically connected to the circuit assembly 600, and can be electrically connected to the external circuit in the electronic device 20 via the circuit assembly 600.

The fixed portion 100 includes a case 110 and a base 120, in which they can engaged with each other. When the optical member driving mechanism 10 is assembled, the movable portion 200, the guiding assembly 300, and the driving assembly 400 can be surrounded by the case 110 and the base 120, so that the impact between the aforementioned members and the other components in the electronic device 20 during the oscillation of the electronic device 20 can be prevented. The reinforcing member 500 can be embedded in a base body 121 of the base 120 to enhance the structural strength. In this embodiment, the reinforcing member 500 includes metal, the base body 120 includes plastic, and the base body 120 can be formed by insert molding to cover the reinforcing member 500.

It should be noted that, although the reinforcing member 500 is covered by the base body 121, a plurality of extending portions 520 that is extended from a bottom plate 510 of the reinforcing member 500 toward the case 110 can still be exposed from the outer surface of the base body 121.

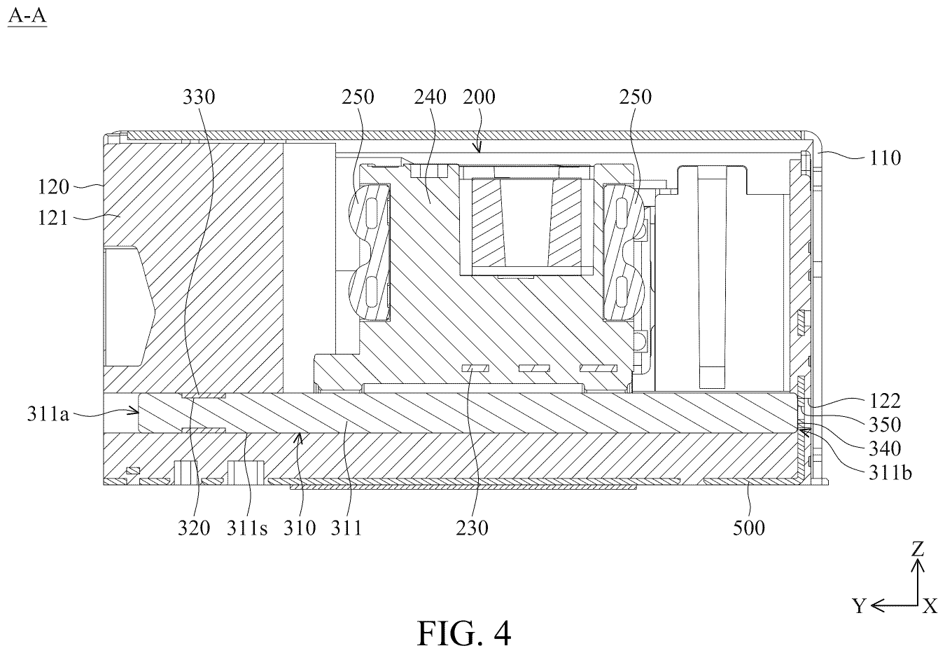

FIG. 4 is a cross-sectional view taken along the line A-A in FIG. 2. As shown in FIG. 2 to FIG. 4, the guiding assembly 300 includes at least one guiding member 310, and a main body 311 of the guiding member 310 can include a longitudinal structure extending along a direction that is parallel to the optical axis 31. A depression structure can be formed on the main body surface 311s of the main body 311, and the depression structure is adjacent to a first end 311a of the main body 311. When the guiding member 310 is mounted to the base 120, a glue can be filled into the depression structure to adhere the main body 311 and the base 120. Otherwise, the base body 120 can also cover the depression structure during the insert molding process, so that a part of the base body 121 can enter the depression structure. Therefore, the depression structure on the main body surface 311s of the main body 311 can be referred as a first fixing unit 320 of the guiding member 310, and the protruding structure (including the glue and/or a part of the base body 121) corresponding to the first fixing unit 320 and protruding toward the main body 311 can be referred as a first corresponding unit 330 of the guiding member 310.

The second end 311b of the main body 311 can be affixed to the reinforcing member 500 by fusion welding. The second end 311b is opposite the first end 311a. In particular, along the optical axis 31, the base body 121 has an opening 122 corresponding to the portion of the main body 311, so that the reinforcing member 500 embedded therein can be exposed from the opening 122, and the exposed reinforcing member 500 can include a corresponding depression structure. The second end 311b of the guiding member 310 can pass through the opening 122 from inside to contact the reinforcing member 500 and connect the depression structure of the reinforcing member 500. The laser can pass through the opening 122 from outside to heat the reinforcing member 500 and the main body 311 of the guiding member 310, so as to fusion weld them. Therefore, the part of the main body 311 at the second end 311b that is configured to fusion weld can be referred as the second fixing unit 340 of the guiding member 310, and the part of the reinforcing member 500 having the depression structure can be referred as the second corresponding unit 350 of the guiding member 310. It should be noted that, in this embodiment, a portion of the second corresponding unit 350 is embedded in the base body 121 and is not exposed therefrom.

Since the first corresponding unit 330 includes glue and/or plastic, and the second corresponding unit 350 includes metal, they are made of different materials. Owing to the first fixing unit 320, the first corresponding unit 330, the second fixing unit 340, and the second corresponding unit 350, the main body 311 of the guiding member 310 can be stably affixed to the base 120.

In this embodiment, the second corresponding unit 350 and the reinforcing member 500 are integrally formed as one piece, but it is not limited thereto. In some embodiments, the second corresponding unit 350 is formed on another metal member that is embedded in the base body 121 and separated from the reinforcing member 500.

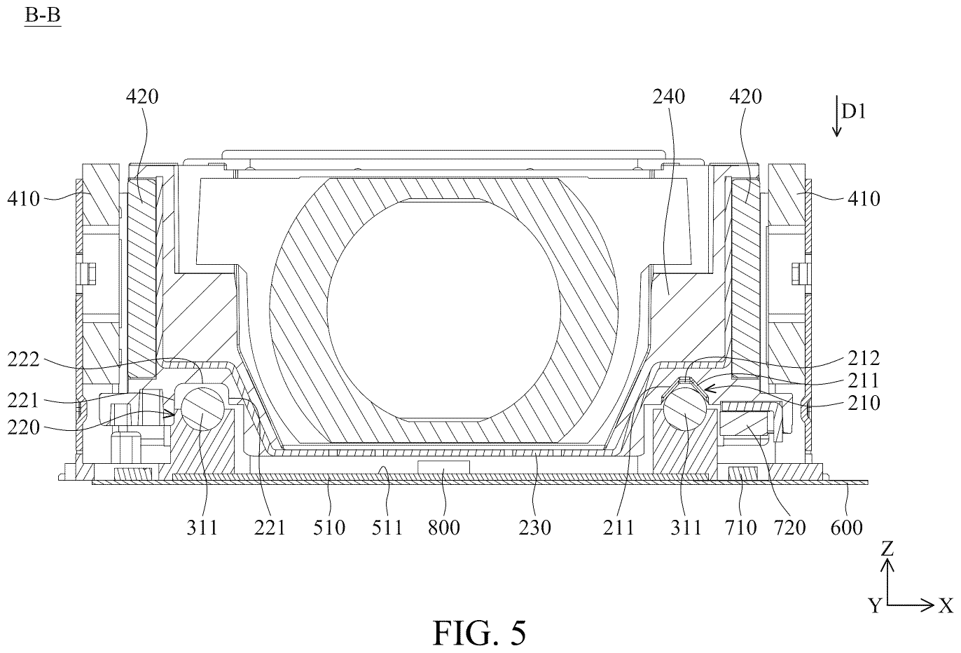

Referring to FIG. 4 and FIG. 5, the movable portion 200 can be slidably connected to the fixed portion 100 through the guiding assembly 300. In detail, the guiding slot corresponding to the guiding member 310 can be formed on the movable portion 200. Therefore, when the driving assembly 400 drives the movable portion 200 to move relative to the fixed portion 100, the guiding slot on the movable portion 200 can move along the guiding member 310, so that the moving direction and the moving stability of the movable portion 200 can be ensured.

In this embodiment, the guiding assembly 300 includes two guiding members 310 that are parallel to each other, and the movable portion 200 includes two guiding slots 210 and 220 respectively corresponding to the aforementioned two guiding members 310. Specifically, the guiding slot 210 and the guiding slot 220 has different cross-section shape. The guiding slot 210 has two lateral surfaces 211 and a top surface 212 disposed between two lateral surfaces 211, and an obtuse angle is formed between the top surface 212 and each of the lateral surfaces 211. Therefore, at least two contacting points can be formed between the guiding slot 210 and the corresponding guiding member 310. The guiding slot 220 has two lateral surfaces 221 and a top surface 222 disposed between two lateral surfaces 221, and the top surface 212 is perpendicular to each of the lateral surfaces 211. Therefore, there is a single contacting point formed between the guiding slot 220 and the corresponding guiding member 310. Thus, the assemble of the optical member driving mechanism 10 and the guide of the movable portion 200 can be facilitated.

The movable portion 200 can further include a permeability member 230 embedded in a movable portion body 240 of the movable portion 200. The optical member driving mechanism 10 can further includes a stabilizing member 800 affixed to a reinforcing member surface 511 of the reinforcing member 500 facing the movable portion 200. A stabilizing force (magnetic attraction force) can be generated between the permeability member 230 and the stabilizing member 800. Therefore, the movable portion 200 can approach the bottom plate 510 by applying the stabilizing force, and the contact between the guiding slots 210 and 220 and the guiding members 310 can be ensured.

In this embodiment, as observed along a first direction D1 (parallel to the Z-axis in the figures) that is perpendicular to the optical axis 31, the optical axis 31 overlaps the stabilizing member 800, so that the inclination of the movable portion 200 can be prevented. For example, the permeability member 230 can include metal with ferromagnetism, the stabilizing member 800 can include magnet, and the movable portion body 240 can include plastic.

As shown in FIG. 4, in the direction that is parallel to the optical axis 31, the stopping members 250 are disposed on the opposite sides of the movable portion 240. For example, the stopping members 250 can be made of elastic material (such as rubber). Thus, the impact between the movable portion 200 and the fixed portion 100 during the movement can be mitigated, and the noise of the optical member driving mechanism 10 can be reduced.

Referring to FIG. 3 and FIG. 5, the driving assembly 400 can include at least one first driving member 410, at least one second driving member 420, and at least one frame 430. The first driving member 410 is affixed to the base 120 through the frame 430, and the second driving member 420 is affixed to the movable portion 200.

For example, the first driving member 410 can be a coil, and the second driving member 420 can be a magnetic member. When current flows through the first driving member 410, the driving force can be generated between the first driving member 410 and the second driving member 420 to push the movable portion 200 to move relative to the fixed portion 100.

The permeability member 230 embedded in the movable portion body 240 can be extended to the position corresponding to the second driving member 420, so that the assemble of the second driving member 420 can be facilitated and the driving effect of the driving assembly 400 can be enhanced. In this embodiment, the second driving member 420 can include a first diving unit 421 and a second driving unit 422, and they can be arranged along the optical axis 31. The first driving unit 421 is closer to the first end 311a of the guiding member 310, and the second driving unit 422 is closer to the second end 311b of the guiding member 310. The dimensions of the first driving unit 421 are less than the dimensions of the second driving unit 422, and the magnetic poles of the first driving unit 421 are the opposite of the magnetic poles of the second driving unit 422.

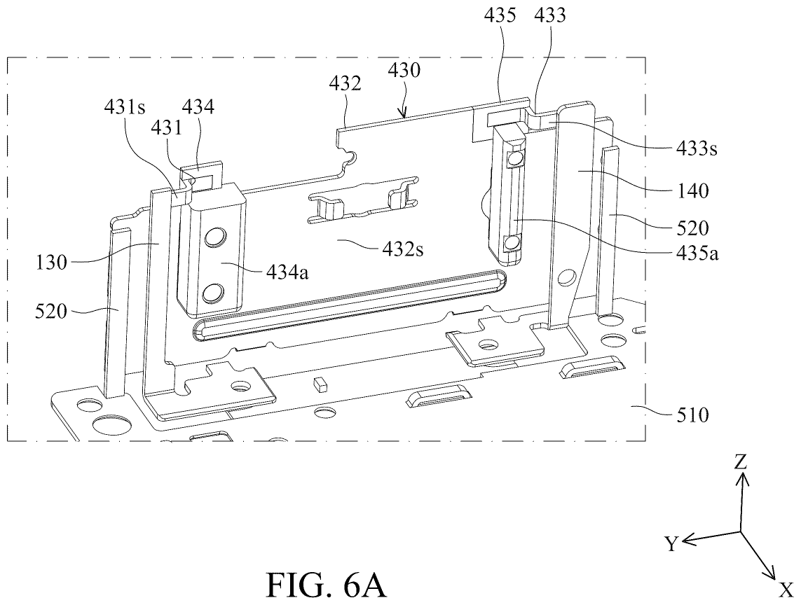

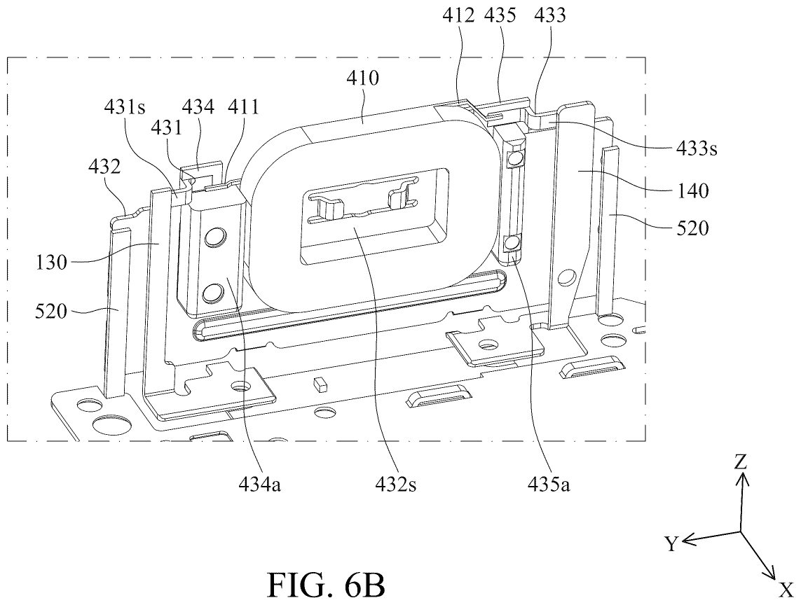

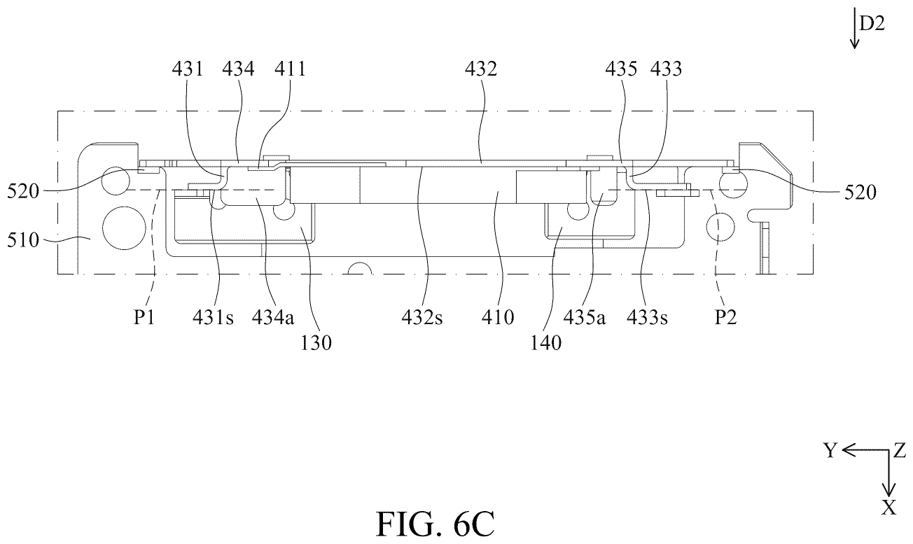

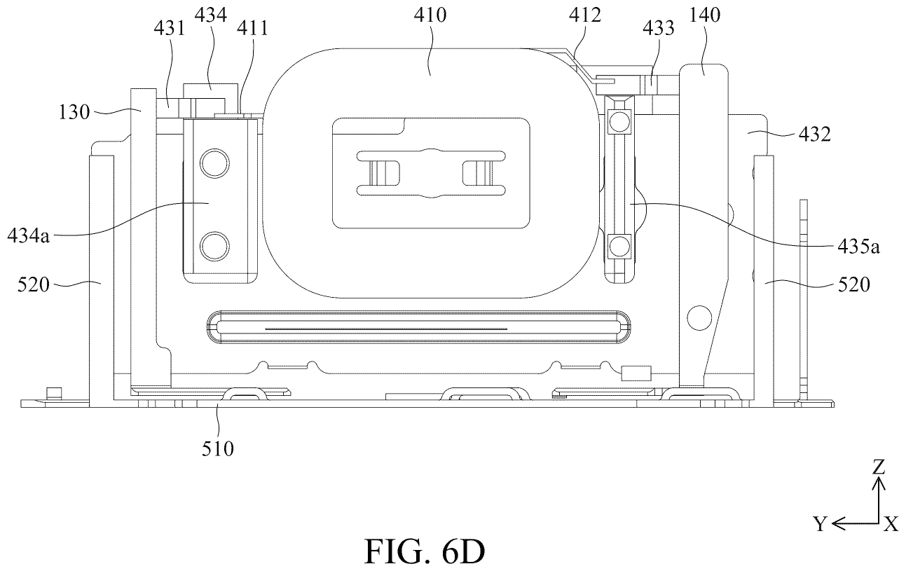

Referring to FIG. 6A to FIG. 6D, the frame 430 can include a first metal member 431, a second metal member 432, a third metal member 433, a first connecting member 434, and a second connecting member 435. The first metal member 431 can be connected to the second metal member 432 via the first connecting member 434, and the third metal member 433 can be connected to the second metal member 432 via the second connecting member 435. The first connecting member 434 and the second connecting member 435 have non-conductive material (such as plastic). Since the first metal member 431 and the second metal member 432 are separated by the first connecting member 434, the third metal member 433 and the second metal member 432 are separated by the second connecting member 435, and the first metal member 431 is not in contact with the third metal member 433, the first metal member 431, the second metal member 432, and the third metal member 433 are electrically isolated from each other.

The second metal member 432 has a flat plate structure. The second metal member 432 can be affixed to the extending portions 520 of the reinforcing member 500 by fusion welding, so that it can be affixed to the base 120. The second metal member 432 has a second metal member surface 432s. When the first driving member 410 is disposed on the frame 430, the second metal member surface 432s faces the first driving member 410, and the first driving member 410 is situated between the first connecting member 434 and the second connecting member 435.

The first metal member 431 has a plate structure, and it can be bent to a Z-shaped appearance. An end of the first metal member 431 can be connected to the first connecting member 434, and a first lead 411 of the first driving member 410 can be connected to the first metal member 431 at this position to electrically connect the first driving member 410 to the first metal member 431. The first metal member 431 has a first metal member surface 431s that is adjacent to the other end of the first metal member 431 and parallel to the second metal member surface 432s. Therefore, the first metal member surface 431s can overlap and be parallel to a first virtual plane P1. The first virtual plane P1 does not overlap the second metal member surface 432s. The first metal member surface 431s is electrically connected to a first circuit member 130 that is embedded in the base body 121.

Similarly, the third metal member 433 has a plate structure, and it can be bent to a Z-shaped appearance. An end of the third metal member 433 can be connected to the second connecting member 435, and a second lead 412 of the first driving member 410 can be connected to the third metal member 433 at this position to electrically connect the first driving member 410 to the third metal member 433. The third metal member 433 has a third metal member surface 433s that is adjacent to the other end of the third metal member 433 and parallel to the second metal member surface 432s, and the third metal member surface 433s and the first metal member surface 431s face the same direction. Therefore, the third metal member surface 433s can overlap and be parallel to a second virtual plane P2. The second virtual plane P2 does not overlap the second metal member surface 432s. The third metal member surface 433s is electrically connected to a second circuit member 140 that is embedded in the base body 121. In this embodiment, the first virtual plane P1 and the second virtual plane are coplanar.

In this embodiment, the distance between the first metal member 431 and the bottom plate 510 of the reinforcing member 500 is different from the distance between the third metal member 433 and the bottom plate 510 of the reinforcing member 500. Therefore, the first metal member surface 431s does not overlap the third metal member surface 433s as observed along the optical axis 31, along the first direction D1 that is perpendicular to the optical axis 31, and along a second direction D2 that is perpendicular to the optical axis 31 and the first direction D1.

The first connecting member 434 and the second connecting member 435 respectively has a first stopping unit 434a and a second stopping unit 435a. When the first driving member 410 is disposed on the second metal member 432, the largest distance between the first and second connecting members 434 and 435 and the second metal member surface 432s is greater than the largest distance between the first driving member 410 and the second metal member surface 432s. Therefore, the moving range of the movable portion 200 in the second direction D2 can be restricted, and the it can prevent the movable portion 200 or the second driving member 420 from impacting the first driving member 410 when the electronic device 20 oscillates.

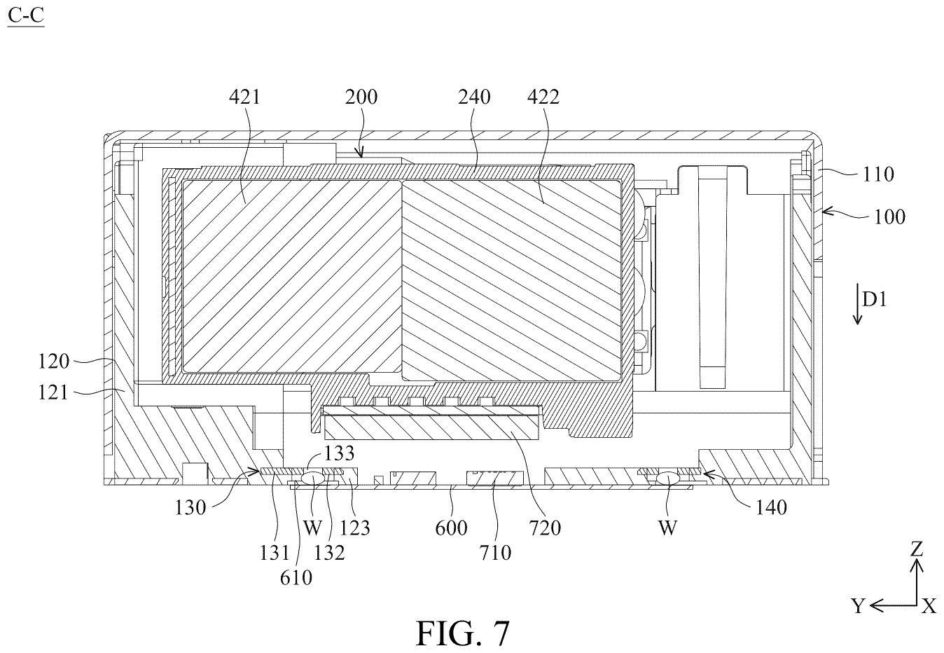

Referring to FIG. 3 and FIG. 7, the circuit assembly 600 can be connected to the base 120 and disposed below the base 120. The first circuit member 130 embedded in the base body 121 can include a welding part 131 that is configured to connect the circuit assembly 600. The base 120 can further include a supporting part 123 corresponding to the welding part 131.

The circuit assembly 600 has a first welding surface 610 facing the welding part 131 of the first circuit member 130. The welding part 131 has a second welding surface 132 facing the first welding surface 610. When the user desires to connect the circuit assembly 600 to the first circuit member 130, a welding member W (such as a solder ball) can be disposed on the first welding surface 610, and then the circuit assembly 600 can be then engaged with the base 120 to let the welding member W be in contact with the second welding surface 132. Specifically, in this embodiment, the welding part 131 has an opening 133. Thus, when the circuit assembly 600 is engaged with the base 120, the user can check that whether the welding member W is in contact with the welding part 131 through the opening 133.

When the circuit assembly 600 is connected to the first circuit member 130, the welding member W is disposed between the first welding surface 610 and the second welding surface 132, and the supporting part 123 can be situated between the first welding surface 610 and the second welding surface 132 to increase the structural strength. In this embodiment, the supporting part 123 and the base body 121 can be integrally formed as one piece.

The connection between the second circuit member 140 and the circuit assembly 600 substantially has the same structure, so that the features thereof are not repeated in the interest of brevity.

Referring to FIG. 3 and FIG. 7, the sensing assembly 700 includes a sensor 710 and a sensing object 720. The sensor 710 is disposed on the circuit assembly 600, and the sensing object 720 is disposed on the movable portion body 240. In the first direction D1, the position of the sensor 710 correspond to the position of the sensing object 720.

For example, the sensor 710 can be a hall sensor, a magnetoresistance effect sensor (MR Sensor), a giant magnetoresistance effect sensor (GMR Sensor), a tunneling magnetoresistance effect sensor (TMR Sensor), or a fluxgate sensor, and the sensing object 720 can be a magnet. Therefore, the sensor 710 can detect the movement of the sensing object 720 to obtain the portion of the movable portion 200 relative to the fixed portion 100.

In this embodiment, the sensor 710 and the sensing object 720 are disposed away from the optical axis 31. Thus, the distances between two guiding members and the sensor 710 are different.

In summary, an embodiment of the present disclosure provides an optical member driving mechanism, including a movable portion, a fixed portion, and a driving assembly. The movable portion is configured to connect an optical member, and is movable relative to the fixed portion. The driving assembly is configured to drive the movable portion to move.

The optical member driving mechanism can further include a guiding assembly, and the movable portion is movable relative to the fixed portion through the guiding assembly. The guiding assembly includes a guiding member and a first corresponding unit. The guiding member includes a main body having a longitudinal structure and a first fixing unit, and the first corresponding unit corresponds to the first fixing unit. The first fixing unit has a depression structure, and the first corresponding unit has a protruding structure entering the first fixing unit.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An optical member driving mechanism, comprising:
a movable portion, configured to connect an optical member;
a fixed portion, wherein the movable portion is movable relative to the fixed portion; and
a driving assembly, configured to drive the movable portion to move.

2. The optical member driving mechanism as claimed in claim 1, wherein the optical member driving mechanism further comprises a guiding assembly, the movable portion is movable relative to the fixed portion through the guiding assembly, and the guiding assembly comprises:
a guiding member, comprising:
a main body, having a longitudinal structure; and
a first fixing unit; and
a first corresponding unit, corresponding to the first fixing unit,
wherein the first fixing unit has a depression structure, and the first corresponding unit has a protruding structure entering the first fixing unit.

3. The optical member driving mechanism as claimed in claim 2, wherein the first fixing unit is formed on a main body surface of the main body.

4. The optical member driving mechanism as claimed in claim 2, wherein the guiding member comprises a second fixing unit, and the guiding assembly comprises a second corresponding unit, the second corresponding unit corresponds to the second fixing unit, and the second corresponding unit has a depression structure.

5. The optical member driving mechanism as claimed in claim 4, wherein the first fixing unit and the second fixing unit are respectively formed on opposite ends of the main body.

6. The optical member driving mechanism as claimed in claim 4, wherein the first corresponding unit and the second corresponding unit are made of different materials.

7. The optical member driving mechanism as claimed in claim 4, wherein the optical member driving mechanism further comprises a frame, a first driving member of the driving assembly is disposed on the frame, and the frame comprises:
a first connecting member;
a first metal member, including metal and having a plate structure; and
a second metal member, including metal and having a plate structure,
wherein the first metal member and the second metal member are electrically isolated from each other,
wherein the first metal member is connected to the second metal member through the first connecting member, and
wherein the first connecting member has a first stopping unit, configured to restrict a moving range of the movable portion.

8. The optical member driving mechanism as claimed in claim 7, wherein:
a first lead of the first driving member is electrically connected to the first metal member,
the first metal member comprises a first metal member surface,
the second metal member comprises a second metal member surface, and the second metal member surface faces the first driving member,
the first metal member surface and the second metal member surface are parallel to each other,
the first metal member surface overlaps a first virtual plane, and the first virtual plane is parallel with the first metal member surface, and
the first virtual plane does not overlap the second metal member surface.

9. The optical member driving mechanism as claimed in claim 8, wherein the first metal member surface and the second metal member surface face the same direction.

10. The optical member driving mechanism as claimed in claim 8, wherein the frame further comprises:
a third metal member, including metal and having a plate structure; and
a second connecting member, wherein the second metal member is connected to the third metal member through the second connecting member,
wherein the first metal member and the third metal member are electrically isolated from each other, and
wherein the second connecting member has a second stopping unit, configured to restrict the moving range of the movable portion.

11. The optical member driving mechanism as claimed in claim 10, wherein at least a portion of the first driving member is disposed between the first connecting member and the second connecting member.

12. The optical member driving mechanism as claimed in claim 10, wherein:
a second lead of the first driving member is electrically connected to the third metal member,
the third metal member comprises a third metal member surface,
the first metal member surface is parallel with the third metal member surface,
the third metal member surface overlaps a second virtual plane, and the second virtual plane is parallel with the third metal member surface, and
the second virtual plane does not overlap the second metal member surface.

13. The optical member driving mechanism as claimed in claim 12, wherein:
the optical member has an optical axis,
as observed along the optical axis, the first optical member surface does not overlap the third optical member surface,
as observed along a first direction, the first optical member surface does not overlap the third optical member surface,
as observed along a second direction, the first optical member surface does not overlap the third optical member surface, and
the first direction, the second direction, and the optical axis are perpendicular to each other.

14. The optical member driving mechanism as claimed in claim 7, wherein the fixed portion comprise a base, the base comprises a base body, and the second corresponding unit is affixed to the base body, wherein at least a portion of the second corresponding unit is embedded in the base body and is not exposed from the base body.

15. The optical member driving mechanism as claimed in claim 14, wherein the base further comprises:
a first circuit member, disposed in the base body; and
a supporting part, corresponding to a welding part of the first circuit member, wherein the supporting part and the first circuit member have different material,
wherein the supporting part and the base body are integrally formed as one piece,
wherein the first circuit member is electrically connected to an external circuit via a circuit assembly, wherein
the circuit assembly has a first welding surface facing the welding part,
the welding part has a second welding surface facing the first welding surface,
at least a portion of the supporting part is disposed between the first welding surface and the second welding surface,
at least a portion of a welding member is disposed between the first welding surface and the second welding surface, and
the welding part has an opening corresponding to the welding member.

16. The optical member driving mechanism as claimed in claim 15, wherein:
the first metal member surface faces the first circuit member,
the optical member driving mechanism further comprises a reinforcing member, the reinforcing member includes metal, and the reinforcing member is connected to the base,
the second metal member is connected to the base through the reinforcing member, and
the second corresponding unit and the reinforcing member are integrally formed as one piece.

17. The optical member driving mechanism as claimed in claim 16, wherein the movable portion comprises a permeability member including metal,
wherein the permeability member corresponds to a second driving member of the driving assembly,
wherein the permeability member corresponds to a stabilizing member, and the stabilizing member is affixed to the fixed portion,
wherein a stabilizing force is generated between the stabilizing member and the permeability member, so as to let the movable portion approach the fixed portion, and
wherein the optical member has an optical axis, and as observed along a first direction that is perpendicular to the optical axis, the optical axis overlaps at least a portion of the stabilizing member.

18. The optical member driving mechanism as claimed in claim 17, wherein the reinforcing member has a reinforcing member surface facing the second metal member, and the stabilizing member is disposed on the reinforcing member surface.

19. The optical member driving mechanism as claimed in claim 2, wherein the optical member driving mechanism comprises a sensing assembly, the sensing assembly comprises a sensor and a sensing object, the sensor is connected to the fixed portion, and the sensing object is disposed on the movable portion,
wherein in a first direction, a position of the sensor corresponds to a position of the sensing object, and
wherein the guiding assembly further comprises an additional guiding member, the additional guiding member is substantially parallel to the guiding member, and in a second direction that is perpendicular to the first direction, a distance between the sensor and the guiding member is different from a distance between the sensor and the additional guiding member.

20. The optical member driving mechanism as claimed in claim 2, wherein the driving assembly comprises a second driving member disposed on the movable portion, the second driving member comprises a first driving unit and a second driving unit, and the first driving unit and the second driving unit are arranged along an optical axis of the optical member,
wherein the dimensions of the first driving unit are different from the dimensions of the second driving unit, and
the magnetic poles of the first driving unit are opposite the magnetic poles of the second driving unit.
